(19) United States
(12) Patent Application Publication
(10) Pub. No.: US 2023/0359558 A1
(43) Pub. Date: Nov. 9, 2023

(54) APPROACH FOR SKIPPING NEAR-MEMORY PROCESSING COMMANDS

(71) Applicant: Advanced Micro Devices, Inc., Santa Clara, CA (US)

(72) Inventors: Shaizeen Aga, Santa Clara, CA (US); Mohamed Assem Abd ElMohsen Ibrahim, Santa Clara, CA (US)

(21) Appl. No.: 17/739,817

(22) Filed: May 9, 2022

(51) Int. Cl. G06F 12/0804

(52) U.S. Cl. CPC G06F 12/0804; G06F 2212/251

(57) ABSTRACT

An approach is provided for skipping, i.e., not processing and/or deleting, near-memory processing commands when one or more skip criteria are satisfied. Examples of skip criteria include, without limitation, specific operations, specific operands, and combinations of specific operations and specific operands. The approach is implemented at one or more memory command processing elements in the memory pipeline of a processor, such as memory controllers, caches, queues, and buffers, etc. Implementations include exceptions to skipping in certain situations and software support for configuring skip criteria, including particular operations and operands for which skip checking is performed. The approach provides the benefits of reducing command bus traffic and power consumption while maintaining functional correctness.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

As computing throughput scales faster than memory bandwidth, various techniques have been developed to keep the growing computing capacity fed with data. Processing In Memory (PIM) incorporates processing capability within memory modules so that tasks can be processed directly within the memory modules. In the context of Dynamic Random-Access Memory (DRAM), an example PIM configuration includes vector compute elements and local registers. The vector compute elements and the local registers allow a memory module to perform some computations locally, such as arithmetic computations. This allows a memory controller to trigger local computations at multiple memory modules in parallel without requiring data movement across the memory module interface, which can greatly improve performance, particularly for data-intensive workloads. Examples of data-intensive workloads include machine learning, genomics, and graph analytics.

One of the challenges with PIM is that some data-intensive workloads issue a large number of PIM commands, which increases command bus congestion and power consumption. There is, therefore, a need for an approach for using PIM that reduces command bus congestion and power consumption.

### BRIEF DESCRIPTION OF THE DRAWINGS

Implementations are depicted by way of example, and not by way of limitation, in the figures of the accompanying drawings and in which like reference numerals refer to similar elements.

FIG. 1 is a flow diagram that depicts an approach for skipping near-memory processing commands.

FIG. 2A is a block diagram that depicts an example computing architecture upon which the approach for skipping near-memory processing commands is implemented.

FIG. 2B depicts an example implementation of the memory controller.

FIG. 3A depicts example pseudo code that includes a PIM Multiply-And-Accumulate (MAC) instruction (pim-MAC) followed by a PIM ADD (pim-ADD) instruction.

FIG. 3B depicts example pseudo code that includes the two instructions of FIG. 3A, but augmented with conditional statements to cause near-memory processing instructions to be dynamically skipped for certain values of immediate operands.

FIG. 3C is a block diagram that depicts two sets of executable code.

FIG. 4 depicts a Skip Checker (SKC) unit implemented in a memory controller as a gatekeeper to a command queue.

FIG. 5 depicts a parameter table of example operations, operands, and combinations of operations and operands that are used by the SKC unit to determine whether a near-memory processing command should be skipped.

FIG. 6 is a flow diagram that depicts an approach for dynamically skipping PIM commands using a SKC unit and skip criteria.

### DETAILED DESCRIPTION

In the following description, for the purposes of explanation, numerous specific details are set forth in order to provide a thorough understanding of the implementations. It will be apparent, however, to one skilled in the art that the implementations may be practiced without these specific details. In other instances, well-known structures and devices are shown in block diagram form in order to avoid unnecessarily obscuring the implementations.
I. Overview
II. Architecture
III. Skipping Near-Memory Processing Commands
   A. Introduction
   B. Dynamic Skipping Near-Memory Processing Commands in Source Code
   C. Dynamic Skipping of Near-Memory Processing Commands Using a Skip Checker Unit and Skip Criteria

### I. Overview

An approach is provided for skipping, i.e., not processing and/or deleting, near-memory processing commands when one or more skip criteria are satisfied. Examples of skip criteria include, without limitation, specific operations, specific operands, and combinations of specific operations and specific operands. The approach is implemented at one or more memory command processing elements in the memory pipeline of a processor, such as memory controllers, caches, queues, and buffers, etc. Implementations include exceptions to skipping in certain situations and software support for configuring skip criteria, including particular operations and operands for which skip checking is performed. The approach provides the benefits of improved performance and reduction in command bus traffic and power consumption while maintaining functional correctness.

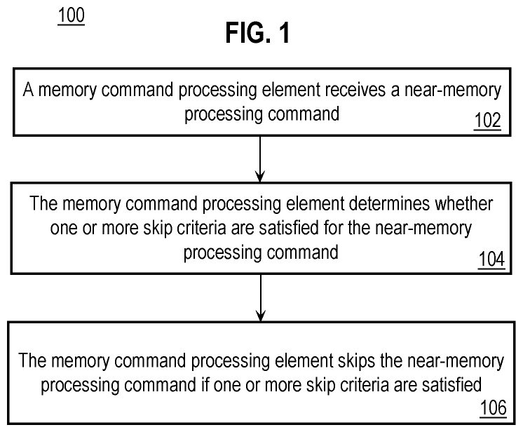

FIG. 1 is a flow diagram 100 that depicts an approach for skipping near-memory processing commands. In step 102, a memory command processing element receives a near-memory processing command. For example, a memory controller receives a PIM command. Implementations are described herein in the context of PIM commands for purposes of explanation, but implementations are applicable to any type of near-memory processing commands.

In step 104, the memory controller selects a memory command for processing. For example, the memory controller selects a memory command from one or more queues based upon various selection criteria.

In step 106, the memory command processing unit skips the near-memory processing command if the one or more skip criteria are satisfied for the near-memory processing command.

### II. Architecture

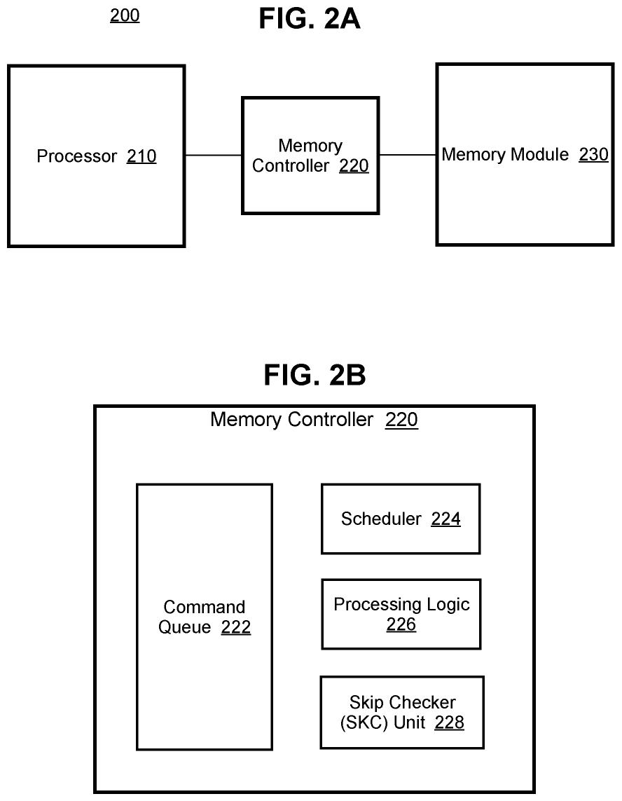

FIG. 2A is a block diagram that depicts an example computing architecture 200 upon which the approach for skipping near-memory processing commands is implemented. In this example, the computing architecture 200 includes a processor 210, a memory controller 220, and a memory module 230. The computing architecture 200 includes fewer, additional, and/or different elements depending upon a particular implementation. In addition, implementations are applicable to computing architectures 200 with any number of processors, memory controllers and memory modules.

The processor 210 is any type of processor, such as a Central Processing Unit (CPU), a Graphics Processing Unit (GPU), an Application-Specific Integrated Circuit (ASIC), a Field-Programmable Logic Array (FPGA), an accelerator, a Digital Signal Processor (DSP), etc. The memory module 230 is any type of memory module, such as a Dynamic Random Access Memory (DRAM) module, a Static Random Access Memory (SRAM) module, etc. According to an implementation the memory module 230 is a PIM-enabled memory module.

The memory controller 220 manages the flow of data between the processor 210 and the memory module 230 and is implemented as a stand-alone element or in the processor 210, for example on a separate die from the processor 210, on the same die but separate from the processor, or integrated into the processor circuitry as an integrated memory controller. The memory controller 220 is depicted in the figures and described herein as a separate element for explanation purposes.

FIG. 2B depicts an example implementation of the memory controller 220 that includes a command queue 222, a scheduler 224, processing logic 226, and a Skip Checker (SKC) unit 228. The memory controller 220 includes fewer or additional elements, such as a page table, etc., that vary depending upon a particular implementation and that are not depicted in the figures and described herein for purposes of explanation. In addition, the functionality provided by the various elements of the memory controller 220, including the scheduler 224, the processing logic 226 and the SKC unit 228, are combined in any manner, depending upon a particular implementation.

The command queue 222 stores memory commands received by the memory controller 220, for example from one or more threads executing on the processor 210. The memory commands include PIM commands and non-PIM commands. PIM commands are directed to one or more memory elements in a memory module, such as one or more banks in a DRAM memory module. The target memory elements are specified by one or more bit values, such as a bit mask, in the PIM commands, and specify any number, including all, of the available target memory elements. PIM commands cause some processing to be performed by the target memory elements in the memory module 230, such as a logical operation and/or a computation. As one non-limiting example, a PIM command specifies that at each target bank, a value is read from memory at a specified row and column into a local register, an arithmetic operation performed on the value, and the result stored back to memory. Examples of non-near-memory processing commands include, without limitation, load (read) commands, store (write) commands, etc. Unlike PIM commands that are broadcast memory processing commands

The command queue 222 is implemented by any type of storage capable of storing memory commands. Although implementations are depicted in the figures and described herein in the context of the command queue 222 being implemented as a single element, implementations are not limited to this example and according to an implementation, the command queue 222 is implemented by multiple elements, for example, a separate command queue for each of the banks in the memory module 230.

The scheduler 224 schedules memory commands in the command queue 222 for processing, for example based upon an order in which the memory commands were received and/or stored in the command queue 222. According to an implementation, the scheduler 224 maintains data, such as a pointer or other indicator, which indicates the next command in the command queue 222 to be processed. The processing logic 226 stores received memory commands in the command queue 222 and is implemented by computer hardware, computer software, or any combination of computer hardware and computer software.

The SKC unit 228 causes one or more near-memory processing commands, such as PIM commands, to be skipped in a manner that maintains correctness when one or more skip criteria are satisfied, as described in more detail hereinafter. The SKC unit 228 is implemented by computer hardware, computer software, or any combination of computer hardware and computer software that varies depending upon a particular implementation. The SKC unit 228 is depicted in the figures and described herein in the context of being implemented in the memory controller 220 for purposes of explanation, but implementations are not limited to this example. As described hereinafter in more detail, implementations include the SKC unit 228 being implemented at different locations in the memory pipeline of a processor, for example, at caches, queues, and buffers.

### III. Skipping Near-Memory Processing Commands

A. Introduction

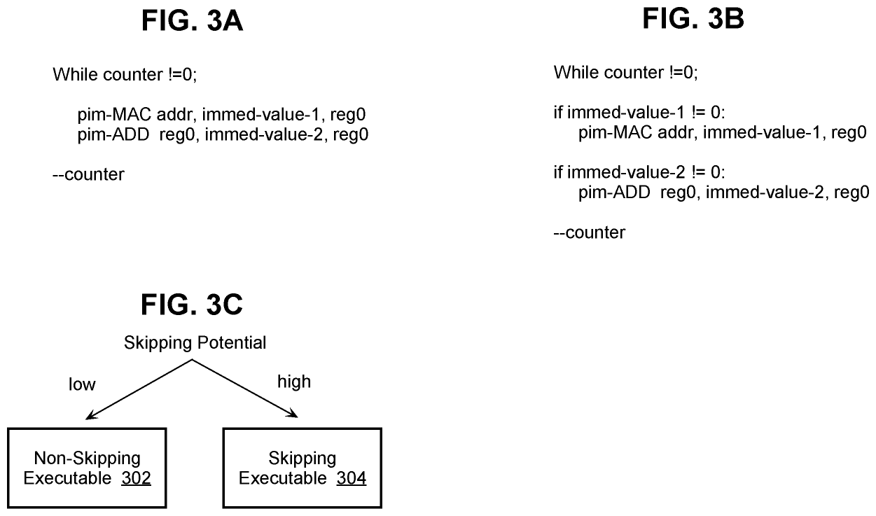

In some situations, PIM commands include operands that are supplied by the host processor, such as a matrix-vector computation where the matrix is resident in memory and the vector elements are provided by the host processor. FIG. 3A depicts example pseudo code that includes a PIM Multiply-And-Accumulate (MAC) instruction (pim-MAC) followed by a PIM ADD (pim-ADD) instruction. Both instructions have associated immediate operands supplied by the host processor orchestrating the PIM computation. In some situations, the values of the immediate operands are such that the corresponding computation can be skipped without affecting correctness.

For example, the pim-MAC instruction of FIG. 3A uses the value stored at address “addr,” multiplies the value by the immediate operand “immed-value-1,” and adds the result to the current value stored in location “reg0,” i.e., register 0. Since the result of the multiplication is added to the current value stored in reg0, if the immediate operand immed-value-1 is zero, then the pim-MAC instruction does not change the current value at the destination, i.e., register 0, regardless of the value at the source location, i.e., at address addr. The pim-MAC instruction can therefore be skipped without affecting correctness, i.e., without changing the value at the destination of register 0.

The pim-ADD instruction uses the value stored in register 0, adds the immediate operand “immed-value-2” to that value, and stores the result in register 0. As with the pim-MAC instruction, if the immediate operand immed-value-1 is zero, then the pim-ADD instruction does not change the current value at the destination, i.e., register 0, regardless of the value at the source location, i.e., register 0.
B. Dynamic Skipping Near-Memory Processing Commands in Source Code

Dynamic skipping of near-memory processing commands may be performed in source code to prevent issuing near-memory processing commands that would otherwise not affect functional correctness, i.e., not change the result in a destination location. FIG. 3B depicts example pseudo code that includes the two instructions of FIG. 3A, but augmented with conditional statements to cause near-memory processing instructions to be dynamically skipped for certain values of immediate operands. The conditional statements cause the pim-MAC command to not be issued if the value of the immediate operand immed-value-1 is zero and the pim-ADD command to not be issued if the value of the immediate operand immed-value-2 is zero. This provides the benefit of avoiding issuing these PIM commands when the values of the respective immediate operands are such that they would not change the value in the destination, i.e., in register reg0.

One of the issues with this approach is that is requires access to source code, which is not always available. Even if the source code is available, the approach adds a conditional instruction for every PIM instruction that has an immediate operand. This increases complexity of the source code and software development time, and incurs additional overhead to process the conditional instructions, even for PIM instructions that are not skipped. Thus, in situations where only a small percentage of PIM instructions are actually skipped, the overhead cost of the conditional instructions may outweigh the benefits provided by skipping the small percentage of PIM instructions, but this is typically not known a priori for a given workload. In addition, depending upon the code structure, the approach can cause thread divergence for GPU implementations and lower performance of the computations when not all of the threads within a lockstep unit either satisfy or don't satisfy the condition.

A refinement of this approach makes two sets of executable, e.g., binary, code available, one with conditional instructions for skipping as described above and one without. One set of executable code is selected based upon the skipping potential, which may be determined based upon the workload domain. For example, it may be known at the application level that the data for particular workload will include a large percentage of multiplication by operations, add zero operations, etc., and that it is cost effective to use code that includes conditional instructions for performing dynamic skipping.

FIG. 3C is a block diagram that depicts two sets of executable code. The non-skipping executable 302 does not include conditional instructions for PIM instructions as previously described and depicted in FIG. 3A, while the skipping executable 304 does include conditional instructions for PIM instructions as previously described and depicted in FIG. 3B. When the skipping potential is low, then the non-skipping executable 302 is selected. When the skipping potential is high, the skipping executable 304 is selected. One of the disadvantages of this “all or nothing” approach is that either none of the benefits of instruction skipping are realized or conditional instruction overhead is incurred for every PIM instruction, even for those instructions that would not have been skipped at runtime. In addition, the potential still exists for thread divergence in GPU implementations.
C. Dynamic Skipping of Near-Memory Processing Commands Using a Skip Checker Unit and Skip Criteria

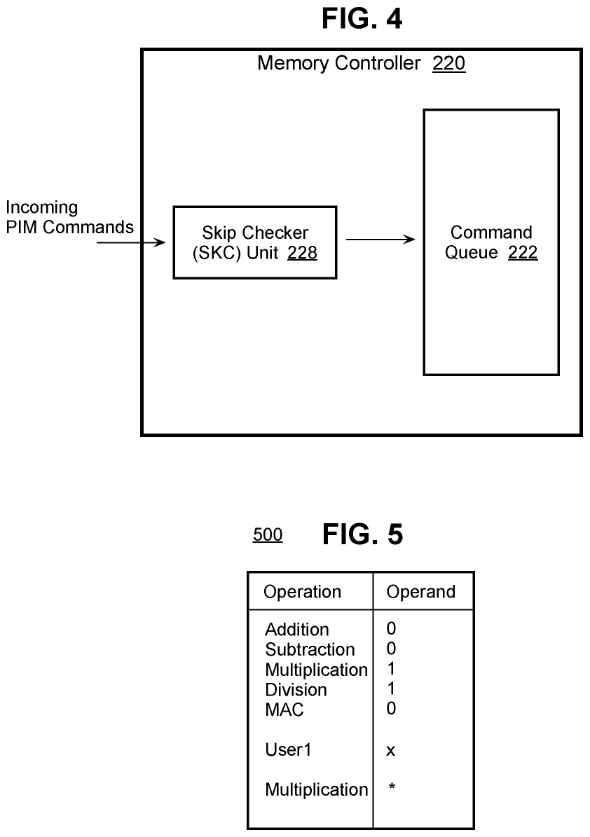

Dynamic skipping of near-memory processing commands is performed by the SKC unit 228 using one or more skip criteria. According to an implementation, incoming PIM commands arriving at the memory controller 220 are evaluated by the SKC unit 228 to determine whether they satisfy any of the skip criteria prior to being enqueued into the command queue 222. Incoming PIM commands that satisfy one or more of the skip criteria are skipped, i.e., not enqueued in the command queue 222 so that they are not processed by the memory controller 220. Alternatively, PIM commands that are determined to satisfy one or more of the skip criteria are enqueued in the command queue 222 but designated for skipping. For example, the SKC unit 228 updates command metadata to specify that a particular PIM command that was determined to satisfy one or more of the skip criteria is to be skipped. The scheduler 224 checks the command data before processing the next command to ensure it is not designated for skipping. If so, the scheduler 224 does not process that command and selects the next command for processing. FIG. 4 depicts the SKC unit 228 implemented in the memory controller 220 as a gatekeeper to the command queue 222. In this implementation, the SKC unit 228 evaluates incoming PIM commands before they are enqueued in the command queue 222.

According to another implementation, instead of PIM commands being evaluated prior to being enqueued into the command queue 222 as depicted in FIG. 4, incoming PIM commands are enqueued normally into the command queue 222 and then evaluated by the SKC unit 228 for skipping after being enqueued. PIM commands are evaluated for skipping at any time after being enqueued, for example periodically, at specified times, or when PIM commands are ready to be processed. For example, the SKC unit 228 evaluates PIM commands using the skip criteria in the same order as the scheduler 224 processes commands in the command queue 222. PIM commands that satisfy the one or more skip criteria are deleted from the command queue 222 and/or a current command pointer is advanced to the next command in the command queue 222.

According to an implementation, skip criteria include, without limitation, specific operations, specific operands, and combinations of specific operations and specific operands. Near-memory processing commands that satisfy the skip criteria can be skipped without affecting functional correctness, i.e., without changing the current value at the destination specified by the near-memory processing command. FIG. 5 depicts a parameter table 500 of example skip criteria in the form of operations, operands, and combinations of operations and operands. As shown in the parameter table 500, all addition, subtraction, and MAC operations with an operand of zero can be skipped. In addition, all multiplication and division operations with an operand of one can be skipped, because none of these combinations of operations and operands affect functional correctness. Embodiments are also applicable to other user-defined operations. For example, the parameter table 500 includes a user-defined operation “Userl” with an operand of “x.”

According to an implementation, the SKC unit 228 determines the operation and operand of a near-memory processing command based upon one or more bit values in a near-memory processing command. For example, a near-memory processing command includes one or more bit values that specify the operation and one or more bit values that specify the operand. The location of the respective bit values are specified, for example, by a command definition or protocol. The SKC unit 228 determines the operation for a near-memory processing command by comparing operation bit values in the command to data that specifies the corresponding operation, such as mapping data stored at the memory controller 220 that maps bit values to operations.

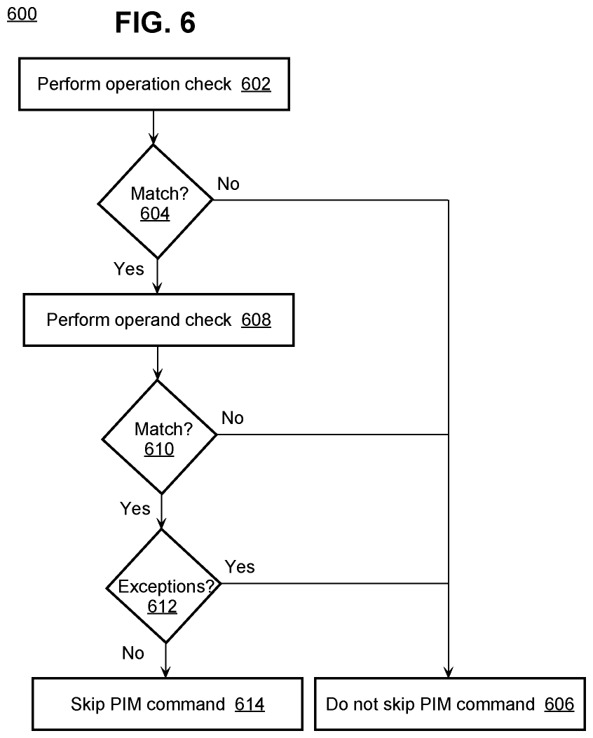

FIG. 6 is a flow diagram 600 that depicts an approach for dynamically skipping PIM commands using the SKC unit 228 and skip criteria. In step 602, an operation check is performed on a selected PIM command. For example, the SKC unit 228 checks whether the operation for the PIM command is one of the operations listed in the parameter table 500. For purposes of discussion, it is presumed that the PIM command is an addition command that corresponds to the second instruction of FIGS. 3A and 3B, namely:
pim-ADD reg0, immed-value-2, reg 0

As previously described herein, this command uses the value stored in register 0, adds the immediate operand “immed-value-2” to that value, and stores the result in register 0.

In step 604, a determination is made whether the operation specified by the PIM command matches any of the commands in the parameter table 500. If not, then control proceeds to step 606 and the PIM command is not skipped. In the present example, since the PIM command is an addition command and the parameter table 500 includes an addition operation as one that can, given certain operands be skipped, control proceeds to step 608 where an operand check is performed. The operand check includes determining whether the operand for the PIM command matches any of the operands in the parameter table 500 for the addition operation. If in step 610 there is no match, then control proceeds to step 606 and the PIM command is not skipped.

If in step 610 the operand for the PIM command does match one of the operands in the parameter table 500 for the addition operation, then control proceeds to step 612 where a determination is made whether any exceptions apply. One example of an exception is a PIM command that is issued for timing purposes, for example, to ensure functional correctness between threads. Such commands typically perform a computation that does not change the current value at a destination, but nonetheless require time to execute. Examples include, without limitation, a PIM command that multiplies the current value at the destination by one, and a PIM command that adds zero to the current value at the destination. According to an implementation, an exception is identified by one or more specified bit values in a PIM command. For example, as indicated by the parameter table 500 of FIG. 5, a PIM command that specifies a multiplication operation with an operand of one satisfies the skip criteria, but if the command includes a bit value that specifies an exception, then control proceeds to step 606 and the PIM command is not skipped. In this implementation, the skip criteria include whether the PIM command specifies, for example via one or more bit values, is not to be skipped. If in step 612 a determination is made that no exceptions apply, then in step 614 the PIM command is skipped.

Although the operation check of step 602 and the operand check of step 608 are depicted in FIG. 6 as being performed serially, implementations are not limited to this example and according to an implementation, the operation check of step 602 and the operand check of step 608 are performed in parallel. The result of the operation check in step 602 and the operand check in step 608 are compared to the data in the parameter table 500 to determine whether the current near-memory processing command should be skipped. For example, the SKC unit 228 implements logic elements for determining whether to perform skipping, where the result of the operation check in step 602 and the operand check in step 608 are used as inputs to the logic elements and the output of the logic elements specifies whether skipping is to be performed. One example implementation of logic elements is a multiplexer where the output of the operation check in step 602 enables or disables the multiplexer and the outputs of the operand check in step 608 are the inputs to the multiplexer. In this implementation, the multiplexer is enabled if the operation of the selected PIM command matches any of the operations in the parameter table 500 and if so, the output value of the multiplexer depends upon whether the operand of the selected PIM command matches the corresponding operand(s) for the operation in the parameter table 500.

### IV. Alternatives, Extensions and Software Support

Although implementations are depicted in the figures and described herein in the context of the SKC unit 228 being implemented in the memory controller 220 for purposes of explanation, implementations include the SKC unit 228 being implemented at other locations in the memory pipeline anywhere from the processor 210 to the memory controller 220, such as caches, queues, buffers, etc. For example, the SKC unit 228 may be implemented at a private or shared cache, such as L1, L2, L3 cache, etc., within the processor 210 so that PIM commands issued by threads are skipped as described herein. This saves the processing resources and power that would normally be required to process the skipped PIM commands at “downstream” elements in the memory pipeline, i.e., after the private or shared cache that has the SKC unit 228. According to an implementation, the SKC unit 228 is implemented at multiple locations in the memory pipeline, such as multiple private caches, queues, buffers, memory controllers, etc. For example, the SKC unit 228 may be implemented at both a cache and the memory controller 220 in the processor 210.

In addition, although the functionality of the SKC unit 228 is depicted in the figures and described herein as being implemented in a separate element, namely, the SKC unit 228, implementations include the functionality of the SKC unit 228 being implemented in existing elements in the memory pipeline, such as the processing logic of the memory controller 220, caches, queues, buffers, etc. For example, according to an implementation, the functionality of the SKC unit 228 is implemented in the processing logic 226 of the memory controller 220.

According to an implementation, the SKC unit 228 is configured to pause skip checking at times of high congestion. For example, the SKC unit 228 pauses skip checking when the current processing level of the SKC unit 228 exceeds a processing level threshold. This prevents the SKC unit 228 from adversely affecting system performance, for example by delaying the scheduler 224 processing commands in the command queue 222. In this implementation, one of the skip criteria is whether the current processing level of the SKC unit 228 exceeds the processing level threshold. According to an implementation, the processing level threshold is configurable using the techniques described herein.

According to an implementation, the approach described herein for dynamically skipping near-memory processing commands is used to skip multiple, e.g., chains, of near-memory processing commands. With this “compound skipping” implementation, multiple near-memory processing commands that store their respective results at the same location and where the net effect of the results of the commands does not change the current value at the location are skipped. For example, consider the following two PIM commands:
PIM-add reg0, immed-value-1, reg 0
PIM-subtract reg0, immed-value-1, reg 0

Both commands store their respective results to the same location, i.e., register reg 0. In addition, the net result of the two commands is zero, regardless of the value of the operand immed-value-1, and therefore the net result of the two commands does not affect the current value stored in reg 0. The SKC unit 228 therefore skips both PIM commands. The compound skipping implementation is applicable to any number of near-memory processing commands, although increasing the number of commands necessarily increases the complexity of the logic implemented by the SKC unit 228. In addition, this implementation is not limited to consecutive near-memory processing commands and is applicable to chains of near-memory processing commands with intervening near-memory processing command that store their results in other locations. For example, consider the following set of PIM commands, which is the same as above except with two other PIM commands in between the first and last PIM command:
PIM-add reg0, immed-value-1, reg 0
PIM-MAC reg1, immed-value-2, reg 1
PIM-add reg2, immed-value-3, reg 2
PIM-subtract reg0, immed-value-1, reg 0

In this example, there are two intervening PIM commands between the PIM-add and PIM-subtract PIM commands directed at reg 0, namely the PIM-MAC command to reg 1 and the PIM-add command to reg 2. The SKC unit 228 evaluates the PIM commands as before and recognizes that the net effect of the PIM-add and PIM-subtract PIM commands does not change the current value stores in register reg 0, in the same manner as above, and therefore the PIM-add and PIM-subtract commands directed to register reg 0 can be skipped. Since the two intervening PIM commands store their results in different locations, i.e., registers reg 1 and reg 2, they are not skipped and are processed normally. According to an implementation, the SKC unit 228 uses a configurable look-ahead threshold that specifies how many near-memory processing commands are considered for compound skipping. For example, if the look-ahead threshold is set to 10, then the SKC unit 228 looks at the next 10 commands stored in the command queue 222. The compound skipping implementation provides the technical benefit of extending the approach beyond the operations and operands specified in the parameter table 500. Skipping is performed for other operations and operands so long as the net effect of multiple near-memory processing commands does not change the current value at the destination location.

According to an implementation, software support is provided for configuring the SKC unit 228, for example to specify the operations and/or operands in the parameter table 500. This allows a software developer to specify specific operations or specific operation/operand combinations to be checked by the SKC unit 228 for a particular workload. For example, a software developer may know that a particular workload involves mostly multiplication operations, so the software developer configures the SKC unit 228 to only check for multiplication operations with an operand of one. This improves performance by eliminating the overhead attributable to checking for other operations and/or operands that are not likely to occur in the workload.

There may be situations, for example during debugging, where it would be beneficial for specific types of near-memory processing commands to be disabled. For example, suppose that it is suspected that near-memory multiplication commands are causing errors in a near-memory processing unit. In this situation it would be beneficial for a software developer to have the capability to disable near-memory multiplication commands to help identify the source of the errors and/or possible remedies for the errors.

According to an implementation, the aforementioned configurability allows a software developer to specify one or more near-memory operations to be skipped, regardless of the operand. For example, as depicted in the parameter table 500 of FIG. 5, the last entry specifies multiplication operations, but with an asterisk “*” for the operand. This causes the SKC unit 228 to skip all near-memory processing commands that specify a multiplication operation for all operands without the software developer having to modify source code. Instead, the software developer can simply update the parameter table 500. In this implementation, the skip criteria include whether a near-memory processing command specifies that a particular operation is not to be skipped.

Implementations also include the ability for a software developer to specify the elements in the memory pipeline where skip checking is performed, for example, whether skip checking is performed at particular memory controllers, caches, queues, buffers, etc. The software support described herein is implemented by separate commands or as new semantics for existing commands. This provides fine granularity for a software developer to specify when, how, and where skip checking is performed, for example, to enable skip checking for certain operations and operands for a first code segment, and disable skip checking for certain operations and operands for a second code segment, which may be in the same or different applications. Alternatively, the SKC unit 228 is pre-configured with particular operations and operands.

1. A memory command processing element comprising:
processing logic configured to skip processing of a near-memory processing command in response to satisfaction of one or more skip criteria.

2. The memory command processing element of claim 1, wherein the one or more skip criteria include whether the near-memory processing command specifies a particular operation.

3. The memory command processing element of claim 1, wherein the one or more skip criteria include whether the near-memory processing command specifies a particular operation and operand.

4. The memory command processing element of claim 1, wherein:
the near-memory processing command specifies an operation and a location where a result of the operation is to be stored, and
the one or more skip criteria include whether the result of the operation is the same as a current value stored at the location where the result of the operation is to be stored.

5. The memory command processing element of claim 1, wherein the one or more skip criteria include whether the near-memory processing command specifies that the near-memory processing command is not to be skipped.

6. The memory command processing element of claim 1, wherein the one or more skip criteria include whether a current processing level of the memory command processing element exceeds a processing level threshold.

7. The memory command processing element of claim 1, wherein the processing logic is further configured to skip a plurality of near-memory processing commands that store their respective results to a same location, and wherein a net result of the plurality of near-memory processing commands is the same as a current value stored at the location.

8. The memory command processing element of claim 1, wherein the memory command processing element is one or more of a memory controller, a cache, a queue, or a buffer.

9. A processor comprising:
processing logic configured to skip processing of a near-memory processing command in response to satisfaction of one or more skip criteria.

10. The processor of claim 9, wherein the one or more skip criteria include whether the near-memory processing command specifies a particular operation.

11. The processor of claim 9, wherein the one or more skip criteria include whether the near-memory processing command specifies a particular operation and operand.

12. The processor of claim 9, wherein:
the near-memory processing command specifies an operation and a location where a result of the operation is to be stored, and
the one or more skip criteria include whether the result of the operation is the same as a current value stored at the location where the result of the operation is to be stored.

13. The processor of claim 9, wherein the one or more skip criteria include whether the near-memory processing command specifies that the near-memory processing command is not to be skipped.

14. The processor of claim 9, wherein the one or more skip criteria include whether a current processing level of the processing logic exceeds a processing level threshold.

15. The processor of claim 9, wherein the processing logic is further configured to skip a plurality of near-memory processing commands that store their respective results to a same location, and wherein a net result of the plurality of near-memory processing commands is the same as a current value stored at the location.

16. The processor of claim 9, wherein the processor is one or more of a Central Processing Unit (CPU), a Graphics Processing Unit (GPU), an Application-Specific Integrated Circuit (ASIC), a Field-Programmable Logic Array (FPGA), an accelerator, or a Digital Signal Processor (DSP).

17. A method comprising:
skipping, by processing logic, processing of a near-memory processing command in response to satisfaction of one or more skip criteria.

18. The method of claim 17, wherein the one or more skip criteria include whether the near-memory processing command specifies a particular operation.

19. The method of claim 17, wherein the one or more skip criteria include whether the near-memory processing command specifies a particular operation and operand.

20. The method of claim 17, wherein:
the near-memory processing command specifies an operation and a location where a result of the operation is to be stored, and
the one or more skip criteria include whether the result of the operation is the same as a current value stored at the location where the result of the operation is to be stored.
